(19) United States
(12) Patent Application Publication
(10) Pub. No.: US 2008/0094589 A1
(43) Pub. Date: Apr. 24, 2008

(54) VIRTUAL DISPLAY AND CONTROL SYSTEM FOR MEDICAL DEVICES

(75) Inventor: Gerald PANITZ, Klenzau (DE)

Correspondence Address: MCGLEW & TUTTLE, PC, P.O. BOX 9227, SCARBOROUGH STATION, SCARBOROUGH, NY, 10510-9227, US

(73) Assignee: DRAGER MEDICAL AG & CO. KG, Lubeck (DE)

(21) Appl. No.: 11/839,092

(22) Filed: Aug. 15, 2007

(30) Foreign Application Priority Data
Oct. 18, 2006 (DE) 10 2006 049 172.6

(51) Int. Cl. G03B 21/00; G09G 5/00

(52) U.S. Cl. 353/122; 345/156

(57) ABSTRACT

A virtual display and control system for medical devices is provided including a patient monitor (5) and/or a therapy device (6) for a patient that is connected to a display and control panel projector (3) via an associated evaluating and control device (4) for the display and control panel projector (3). The display and control panel projector (3) is set up to project a display and control panel preset by the evaluating and control device (4) onto a projection surface (7) in the patient care area connected to the patient monitor (5) and/or to the therapy device (6). The display and control panel projector (3) is set up by means of at least one optical sensor element to detect the current manual occupation of the display and control panel.

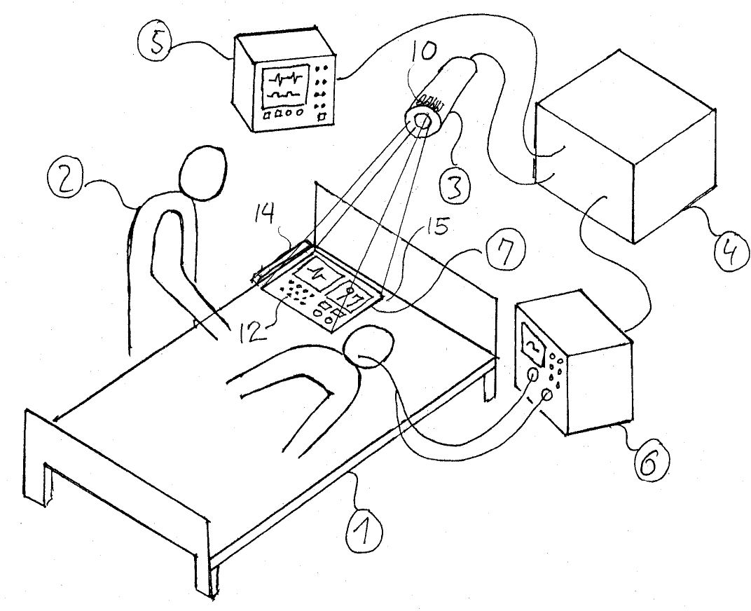

### CROSS REFERENCE TO RELATED APPLICATIONS

This application claims the benefit of priority under 35 U.S.C. § 119 of German Patent Application DE 10 2006 049 172.6 filed Oct. 18, 2006, the entire contents of which are incorporated herein by reference.

### FIELD OF THE INVENTION

The present invention pertains to a virtual display and control system for medical devices, especially for patient monitors or therapy devices.

### BACKGROUND OF THE INVENTION

Nearly all modern medical devices are controlled or monitored by microcontroller systems. The control is carried out, as a rule, via device-specific electronic displays and readable control panels. Examples of such medical devices are anesthesia apparatuses and respirators, patient monitors for hemodynamic monitoring, electronically controlled breathing gas humidifiers, operating lamps, electrically actuated operating tables, control units for illuminating and air conditioning rooms used for medical purposes, and personal computers for logging medical procedures.

For example, the following types of operational controls are used here: Conventional PC keyboards, PC keyboards of a special design, for example, of the splash-proof design for logging anesthesia in the operating room, device-specific membrane keyboards, for example, for infusion pumps, device-specific control panels with electromechanical elements, such as potentiometers, toggle switches or slider controls for imaging diagnostic devices.

The various types of control panels are also frequently combined. Information, such as the states of the device, measured values or alarm reports are also visually displayed in many cases to the user of the medical devices in the immediate vicinity of the operational controls. The display elements used range here from simple status lights and bar displays to graphic display screens via alphanumeric luminous displays.

The patient with the primarily necessary activities for diagnosis, care and therapy is in the center of nearly all medical actions. Device interactions between the medical staff, which is also called “user,” and the medical devices are necessary based on the particular technical design of the devices. Either functions are activated for supporting the therapy or the devices are switched by such interactions to states in which they do not interfere with the care action and are not currently performing reasonable actions. The display and control panels are designed in many different locations in various embodiments corresponding to the position, type and number of the particular medical devices. This results in the problem for the user that user must frequently interrupt the care action proper or the medical treatment at the patient in order to perform settings on one of the many medical devices distributed in the room. The drawbacks arising herefrom, for example, the time needed, the necessary switching of attention due to different display and control environments, are apparent.

### SUMMARY OF THE INVENTION

Consequently, the object of the present invention is to provide a display and control system for medical devices that is improved in terms of perceptibility and handling for the user.

According to the invention, a virtual display and control system is provided for medical devices. The system comprises a patient monitoring device and/or a therapy device for a patient, an evaluating and control device and a display and control panel projector. The patient monitoring device and/or a therapy device is connected to the display and control panel projector via the evaluating and control device for controlling a display of the display and control panel projector. A surface in a patient care area is provided to act as a projection surface. The display and control panel projector is set up to project a display and control panel image, including projected display features preset by the evaluating and control device, onto the projection surface in the patient care area. An optical sensor element is provided. The display and control panel projector detects a manually input state of the display and control panel with the optical sensor element.

The optical sensor element is an optical semiconductor sensor element. This may be a row or a matrix of charge coupled device (CCD) sensor elements mounted on the display and control panel projector. The display and control panel projector may comprise laser diodes and/or an additional optical detection elements with a tracking means for directing the display and control panel projector towards a certain projection surface. An infrared optical laser distance measuring means may be provided for detecting the manual occupation in the display and control panel.

The patient monitoring device detects physiological parameters of the patient. The therapy device may advantageously be one of an anesthesia apparatus or a respirator, an incubator, an open care unit or a intensive care bed.

The evaluating and control device may be equipped with an input unit for controlling the display and control panel projector. The patient monitor and the therapy device and the evaluating and control device may be bidirectionally connected for data communication in a wireless manner.

An essential advantage of the virtual display and control system arises from the use of a controllable display and control panel projector to project a display and control panel onto a suitable projection surface in the care area of the patient, who is connected to the patient monitor and/or to the therapy device.

The optical sensor element, preferably a CCD (Charge Coupled Device) element, is equipped such that it can resolve the current manual occupation, for example, by a finger activating an area of the keyboard of the display and control system, and, for example, distinguish it from a finger that is only floating. As an alternative or in addition, another optical sensor element, for example, an infrared optical laser distance measurement, can be used to detect the activation of the key in the virtual display and control system by an optical distance measurement taking place at a short distance in parallel to the projection surface.

Exemplary embodiments of a virtual display and control system for medical devices will be explained below by means of the only, schematic figure, which explains the essential elements of the system. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

The only FIGURE is a schematic view of a virtual display and control system for medical devices according to the invention.

### DESCRIPTION OF THE PREFERRED EMBODIMENT

Referring to the drawings in particular, the figure shows a patient in an intensive care bed 1 of an intensive care unit of a hospital as a care area for the medical treatment. The user 2 is, for example, a medical care provider at the intensive care bed 1 of the patient.

The display and control panel projector 3 projects the elements of a display and control panel to provide a projected display 7 on a projection surface 15 such as bed 1, an adjacent tray (such as a structure connected to the bed) or other surface (such as a clipboard) in the patient care area. The projection surface 15 is located, for example, at a location on the sheet of the intensive care bed 1 in the vicinity of the patient's head. As an alternative, the projection surface 15 may be projected, for example, onto a clipboard or onto a tray within the reach of the user 2. The current input status of the display and control panel is detected by means of an optical sensor element 10 in or at the display and control panel projector 3. The optical sensor element 10 may also be fixed in the patient environment such as to the patient care bed 1 or may be both at the display and control panel projector 3 and at another location as well. The optical sensor element 10 is a CCD (Charge Coupled Device) element and is provided to detect manual actuation, for example, by a finger activating an area of the virtual actuator, softkey or projected keyboard 12 of the projected display 7. The optical sensor element 10 can for example distinguish such actuation from a finger that is only floating. As an alternative or in addition, another optical sensor element 14, for example, an infrared optical laser distance measurement, can be used to detect the activation of the key in the virtual display and control system by an optical distance measurement taking place at a short distance in parallel to the projection surface 15. The optical detector element 10 of the display and control panel projector 3 as well as the another optical sensor element 14 has a tracking means so that the display and control panel is automatically projected onto a desired location with the desired direction.

An evaluating and control device 4, which controls the display and control panel projector 3, receives data from medical devices and sends entries made by the user 2 via the projected display and control panel to medical devices. The evaluating and control device 4 is equipped with corresponding communications and evaluation programs, among other things, for formatting medical device-specific display and control panels. A hemodynamic patient monitor 5 and a therapy device 6, which is designed as an intensive care respirator here, are shown as examples of medical devices that send information to the evaluating and control device 4 so that this device can generate and project a display and control panel that corresponds to the particular context.

The projected display and control panel 7 is equipped with operational controls in the form of the virtual actuators, softkeys or projected keyboard 12 such as alphanumeric keys or with symbol elements for specific functions or with functional elements such as soft switches, slider controls, adjusters and displays for measured values or states of the device.

Which current situation happens to be present actuation status/operation status is decided either by operating the evaluating and control device 4 or automatically by the optical sensor element 10,14 on the basis of the measured values or even by information of the connected medical devices or by operating the projected display 7 in the form of the control panel being permanently projected, via the optical sensor element 10, 14 during the operation. The device-specific displays and operational controls of electronically controlled medical devices are projected with the present virtual display and control system for medical devices in an advantageous manner for medical users 2 as virtual display and control panels at a centrally accessible location, which can easily be reached by the user 2 during the performance of medical treatment and care activities, without the user 2 having to interrupt the care activity.

A plurality of display and control panel projectors 3 are arranged, for example, above the intensive care bed 1 for use in an intensive care unit. For example, the corresponding mode is started via the evaluating and control device 4, for example, for oral hygiene, at the beginning of a treatment procedure, and a display and control panel as the projected display 7 is projected onto a projection surface 15 in the vicinity of the patient's head.

The display and control panel of the projected display 7 fits the current situation via the evaluating and control device 4. Thus, it contains, for example, the following display elements at the beginning of the treatment: “Pre-oxygenation on/off,” “Silence” and “Exhaust on/off.” Depending on the further course, individual elements are not displayed any longer, and others, for example, a slider control for the exhaust vacuum, control elements for adjusting the bed, measured values for the 2 saturation, the heart rate, etc., are newly added.

The user 2 can now operate the different medical devices without having to turn or move away from the patient, and he or she has all the displays that are important now directly within the user's view.

For use at a patient who is already connected to sensors for initiating anesthesia, the corresponding mode is activated on the evaluating and control device 4, with the consequence that a display and control panel is projected onto the patient's chest. The user 2, who is standing besides the patient's head, can adjust the necessary controls of the device for the therapy device 6, which is designed as an anesthesia apparatus in one embodiment, by the indicated touching of the virtual keys 12 of the display and control panel, for example, “Fresh gas stop/start,” “Ventilation stop/start” and “Adjust O₂ concentration.”

For use during an ongoing operation, corresponding control panels for controlling medical devices for minimally invasive surgery, operating lamps, controlling the operating table or for communication are projected onto a sterile projection surface next to the operating area. Thus, the surgeon does not need to touch any possibly nonsterile elements and he does not have to turn away from the operating area in order to be able to control the functions.

For use in neonatology, the medical user 2 carries out, for example, a treatment or care activity on a mechanically respirated patient lying in an incubator. The user wears sterile gloves for this and inserts the user's arms through the flaps of the incubator. If the incubator hood has a corresponding design or a display and control panel projector 3 is positioned correspondingly in the incubator, all needed operational controls such as “Alarm Silence,” “Start sensor calibration,” are projected onto the bed surface. The user does not have to pull his arms out of the incubator to control the device with all the disadvantages associated therewith concerning the fact that sterility is no longer guaranteed, time is lost, etc.

In summary, the following advantages are achieved by the virtual display and control system being described:

The user 2 is relieved of physical stress and does not have to leave the user's place in the patient care area.

The cognitive stress for the user 2 is reduced because only the displays and operational elements that are relevant in the particular situation are displayed at a selected central location.

Hygienic impairments due to the operation of different medical devices are very extensively reduced because the projection surfaces 7 have the same hygiene status as the hands of the user 2. The contents and the shape of the display and control panel are determined solely by evaluating and configuration software for the evaluating and control device 4. Thus, depending on the situation and the requirements, the contents and the size of the projected elements can be freely adapted.

The patient's safety is markedly increased because all the data relevant for the current therapeutic situation are located permanently within the field of view of the user 2.

No mechanical components are necessary, unlike in the case of, e.g., remote control or special keyboards. Cables and plugs are likewise eliminated, so that no time-consuming set-up is necessary. Hardware components causing costs are likewise eliminated.

While specific embodiments of the invention have been shown and described in detail to illustrate the application of the principles of the invention, it will be understood that the invention may be embodied otherwise without departing from such principles.

What is claimed is:

1. A virtual display and control system for medical devices, the system comprising:
a patient monitoring device and/or a therapy device for a patient;
an evaluating and control device;
a display and control panel projector, said patient monitoring device and/or a therapy device being connected to said display and control panel projector via said evaluating and control device for controlling a display of said display and control panel projector;
a surface in a patient care area to act as a projection surface, said display and control panel projector being set up to project a display and control panel image, including projected display features preset by said evaluating and control device, onto said projection surface in the patient care area; and
an optical sensor element, said display and control panel projector detecting a manually input state of said display and control panel with said optical sensor element.

2. A virtual display and control system in accordance with claim 1, wherein said optical sensor element is an optical semiconductor sensor element.

3. A virtual display and control system in accordance with claim 2, wherein said optical semiconductor sensor element is a row or a matrix of charge coupled device sensor elements mounted on said display and control panel projector.

4. A virtual display and control system in accordance with claim 1, wherein said display and control panel projector comprises laser diodes and/or an additional optical detection elements with a tracking means for directing said display and control panel projector towards a certain projection surface.

5. A virtual display and control system in accordance with claim 1, further comprising an infrared optical laser distance measuring means for detecting the manual occupation in the display and control panel.

6. A virtual display and control system in accordance with claim 1, wherein said patient monitoring device detects physiological parameters of the patient.

7. A virtual display and control system in accordance with claim 1, wherein said therapy device is one of an anesthesia apparatus or a respirator, an incubator, an open care unit or a intensive care bed.

8. A virtual display and control system in accordance with claim 1, wherein said evaluating and control device is equipped with an input unit for controlling said display and control panel projector.

9. A virtual display and control system in accordance with claim 1, wherein said patient monitor and said therapy device and said evaluating and control device are bidirectionally connected for data communication in a wireless manner.

10. A medical treatment display and device control process comprising the steps of:
providing a patient monitoring device and/or a therapy device for a patient;
providing an evaluating and control device;
providing a display and control panel projector;
connecting the patient monitoring device to the display and control panel projector via said evaluating and control device;
providing a surface in a patient care area as a projection surface;
projecting a display and control panel on the projection surface using the display and control panel projector with the display and control panel projected having features preset by the evaluating and control device with variations in content controlled by the evaluating and control device; and
actuating features of the patient monitor and/or a therapy device for changing the settings or state thereof by a manual user input in an area of the display and control panel projected by the display and control panel projector with the actuation being input by a user by detection with an optical sensor element.

11. A medical treatment display and device control process in accordance with claim 10, wherein said optical sensor element is an optical semiconductor sensor element.

12. A medical treatment display and device control process in accordance with claim 11, wherein said optical semiconductor sensor element is a row or a matrix of charge coupled device sensor elements.

13. A medical treatment display and device control process in accordance with claim 10, wherein the optical sensor element comprises laser diodes and/or additional optical detection elements with a tracking means for directing said display and control panel projector towards a certain projection surface.

14. A medical treatment display and device control process in accordance with claim 10, further comprising providing an infrared optical laser distance measuring means for detecting the manual occupation in the display and control panel.

15. A medical treatment display and device control process in accordance with claim 10, wherein the patient monitoring device detects physiological parameters of the patient.

16. A medical treatment display and device control process in accordance with claim 10, wherein the therapy device is one of an anesthesia apparatus or a respirator, an incubator, an open care unit or a intensive care bed.

17. A medical treatment display and device control process in accordance with claim 10, wherein the evaluating and control device is equipped with an input unit for controlling the display and control panel projector.

18. A medical treatment display and device control process in accordance with claim 10, wherein the patient monitoring device and the therapy device and the evaluating and control device are bidirectionally connected for data communication in a wireless manner.

19. A medical treatment virtual display and control system comprising:
a patient care area for medical treatment, the care area including at least a surface providing a projection surface;
a patient monitoring device and/or a patient therapy device;
an evaluating and control device;
a display and control panel projector, said patient monitor being connected to said display and control panel projector via said evaluating and control device for controlling said display and control panel projector;
an optical sensor element for optically detecting a manual input by a user, said display and control panel projector projecting features of the display and control panel preset by said evaluating and control device onto said projection surface in the patient care area.
